(19) United States
(12) Patent Application Publication
(10) Pub. No.: US 2003/0147779 A1
(43) Pub. Date: Aug. 7, 2003

(54) Low volume micro-plate and volume-limiting plugs

(76) Inventors: Arezou Azarani, San Jose, CA (US); David J. Wright, San Mateo, CA (US); Kenneth Christensen, Makawao, HI (US); Jesse Cohen, Palo Alto, CA (US)

Correspondence Address: Larry B. Guernsey, Esq., IPLO, Intellectual Property Law Offices, 1901 S. Bascom Avenue, Suite 660, Campbell, CA, 95008, US

(21) Appl. No.: 10/345,607

(22) Filed: Jan. 15, 2003

Related U.S. Application Data
(60) Provisional application No. 60/349,776, filed on Jan. 16, 2002.

(51) Int. Cl. B01L 3/00

(52) U.S. Cl. 422/99; 422/102

(57) ABSTRACT

A system (10) for reducing volume of material used in laboratory processes, including a low-volume micro-plate (70,80) having a number of wells (14) bound together with matrix material (16), where the wells include secondary wells (74, 84) having reduced volume, and volume limiting plugs (20). The volume limiting plugs (20) have a shank portion (30) and a tip portion (28), where the shank and tip portions (20,30) are configured to extends a substantial distance into a well (14) of the multi-well plate (70,80) to reduce the volume of the well. Also volume limiting plugs (20) for use with standard multi-well plates and low-volume micro-plates (70,80) for use with standard plugs.

The following claims priority from U.S. provisional application serial No. 60/349,776, filed Jan. 16, 2002, which has the same inventors as the present application.

### TECHNICAL FIELD

The present invention relates generally to processing of DNA samples and more particularly to apparatus for DNA sequencing and amplification.

### BACKGROUND ART

A fundamental area of interest in modern molecular biology is concerned with the isolation and amplification of DNA sequences. The genetic framework, or the genome, of an organism is encoded in the double-stranded sequence of nucleotide bases in the deoxyribonucleic acid (DNA) which is contained in the somatic and germ cells of the organism. The genetic content of a particular segment of DNA, or gene, is only manifested upon production of the protein which the gene ultimately encodes. There are additional sequences in the genome that do not encode a protein (i.e., “noncoding” regions) which may serve a structural, regulatory, or unknown function. Thus, the genome of an organism or cell is the complete collection of protein-encoding genes together with intervening noncoding DNA sequences.

Fundamental operations conducted by molecular biologists include amplification and sequencing of DNA molecules. Sequencing includes any lab technique used to find out the sequence of nucleotide bases in a DNA molecule or fragment. Amplification involves an increase in the number of copies of a specific DNA fragment, either in a living organism or in a laboratory apparatus. One of the most successful techniques for DNA amplification is by polymerase chain reaction (PCR).

Polymerase chain reaction (PCR) is a powerful analytical tool permitting the amplification of any desired specific nucleic acid sequence contained in a nucleic acid or mixture thereof. DNA polymerases synthesize the formation of DNA molecules which are complementary to a DNA template. The PCR method for amplifying a DNA base sequence uses a heat-stable polymerase and two multiple-base primers, one complementary to the (+)-strand at one end of the sequence to be amplified and the other complementary to the (−)-strand at the other end. Because the newly synthesized DNA strands can subsequently serve as additional templates for the same primer sequences, successive rounds of primer annealing, strand elongation, and dissociation produce rapid and highly specific amplification of the desired sequence. PCR also can be used to detect the existence of the defined sequence in a DNA sample.

PCR permits the copying, and resulting amplification, of a target nucleic acid. Briefly, a target nucleic acid, e.g. DNA, is combined with a sense and antisense primers, dNTPs, DNA polymerase and other reaction components. The sense primer can anneal to the antisense strand of a DNA sequence of interest. The antisense primer can anneal to the sense strand of the DNA sequence, downstream of the location where the sense primer anneals to the DNA target. In the first round of amplification, the DNA polymerase extends the antisense and sense primers that are annealed to the target nucleic acid. The first strands are synthesized as long strands of indiscriminate length. In the second round of amplification, the antisense and sense primers anneal to the parent target nucleic acid and to the complementary sequences on the long strands. The DNA polymerase then extends the annealed primers to form strands of discrete length that arc complementary to each other. The subsequent rounds serve to predominantly amplify the DNA molecules of the discrete length.

This process for amplifying the target sequence involves introducing a molar excess of two oligonucleotide primers which are complementary to their respective strands of the double-stranded target sequence to the DNA mixture containing the desired target sequence. The mixture is denatured and then allowed to hybridize. Following hybridization, the primers are extended with polymerase so as to form complementary strands. The steps of denaturation, hybridization, and polymerase extension can be repeated as often as needed, in order to obtain relatively high concentrations of a segment of the desired target sequence.

In laboratory operations, PCR or cycle sequencing is done in a PCR machine, usually by distributing DNA samples into a multi-well plate, typically having either 96 or 384 wells. Reagents such as enzymes, primers, buffers and dNTP are added, and then the mixture is thermally cycled normally 20-30 times to enable the reaction. Heat is generally applied from a Peltier module in the pedestal on which the well-plate is seated. There is also generally a heating plate on top of the sample to prevent sample evaporation/condensation. The heat lid constantly maintains higher temperature (103 degree C.) than the cycle pedestal, so that during the cycle reaction, the sample liquid/reagent in the well will not evaporate and liquid won't condensate on the top of the well. This helps the concentrations of PCR reaction ingredients to remain unchanged since the concentrations of the PCR reaction ingredients are critical.

As PCR has been found to introduce sequence errors into the process and is limited to amplification of short DNA segments, another technique known as RCA for Rolling Circle Amplification has also come into use. RCA also involves the step of heating mixtures of DNA samples and reagents.

Both techniques involve the use of enzymes which are very expensive. A large portion of the cost incurred by DNA sequencing and amplification is due to the high cost of the enzyme, primers, dNTP and dye terminators used during cycle sequencing or PCR. The multi-well plates used in these operations typically hold volumes of 50 μL (50 micro-liter=50 ×10⁻⁶ liters) of material. Although this seems a minute quantity by everyday standards, it is estimated that enzymes in quantities and concentrations recommended by the supplier can cost in excess of $7.00 per reaction. Since some labs now reach throughputs in excess of 100,000 samples per day, the cost of performing the cycle sequencing reaction alone can represent a significant amount of the total cost of obtaining sequencing data.

To reduce this cost, many laboratories have reduced the reaction volumes and diluted the stock enzyme/dye mix (referred to as ‘brew”). Reduced volume of material has natural advantages in reduction of costs, as for instance, a factor of 10 reduction in volume can be expected to produce a factor of 10 reduction in cost of material used. However, substantial dilution of brews can lead to degradation of sequence quality, presumably because of decreased nucleotide and enzyme concentrations.

Unfortunately, there are technical problems limiting volume reduction as well. Reduced volume compared to surface area can result in excessive evaporation of the sample during heat cycling. Also, reduced volume gives more top space for condensation during the cool cycle, when the temperature typically changes from 96 to 50 degree C. There can also be difficulties in handling samples of such small volume.

There have been various devices through the years which are used to close the openings of arrays of vials. Some examples are U.S. Pat. No. 5,112,574 to Horton, U.S. Pat. No. 5,005,721 to Jordan, U.S. Pat. No. 6,136,273 to Seguin, U.S. Pat. Nos. 5,544,778 and 5,702,017 to Goncalves, U.S. Pat. No. 4,599,314 to Shami, and U.S. Pat. No. 5,282,543 to Picozza. These devices are effective in sealing the contents of the vials inside, but are not designed to significantly reduce volume of the wells, nor to transfer heat to the wells contents.

Thus, there is a need for a system that allows for reduced volumes of material to be processed, but without the disadvantages of excessive evaporation and condensation during cooling that have been problems typical of prior systems which have used reduced volume of reagents.

### DISCLOSURE OF INVENTION

Accordingly, it is an object of the present invention to provide a system which allows use of volumes of material which are preferably reduced by as much as a factor of 40 (from a 20 μL to a 0.5 μL total reaction volume).

Another object of the invention is to produce a system in which the cost of processing is also reduced by as much as a factor of 40.

A further object of the present invention is to provide a system which can be used in either 96-well or 384-well format and provides either a new configuration of well structures, or which is adaptable to use with existing multi-well plates and processing equipment.

An additional object of the present invention is to provide a system in which problems due to evaporation and condensation of materials such as variations in reactant concentrations is minimized.

Briefly, one preferred embodiment of the present invention is a system for reducing volume of material used in laboratory processes. The system includes a low-volume micro-plate having a number of wells bound together with matrix material, where the wells include secondary wells having reduced volume, and volume limiting plugs. The volume limiting plugs have a shank portion and a tip portion, where the shank and tip portions are configured to extends a substantial distance into a well of a multi-well plate to reduce the volume of the well.

Also disclosed are low-volume micro-plates and volume limiting plugs for use with the multi-well plates.

An advantage of the present invention is that reduced volumes of material can be used, thus decreasing material costs, and decreasing quantities of materials to which laboratory personnel are exposed.

And another advantage of the present invention is that problems of evaporation and condensation on the tops of the wells of materials are reduced greatly.

A further advantage of the present invention is that the system can utilize either 96-well or 384-well formats.

A yet further advantage is that the system is adaptable to use with existing multi-well plates and processing equipment.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 shows a PCR machine which uses the system of the present invention;

FIG. 2 illustrates a cross-sectional view as taken through line 2-2 of FIG. 1;

FIG. 3 shows a detail view as seen in detail circle A of FIG. 2;

FIG. 4 illustrates a cross-sectional view of a standard 50 μL multiwell plate of the prior art;

FIG. 5 shows the plugs of the present invention in use with a standard 50 μL multiwell plate which uses discrete plugs;

FIG. 6 shows a second embodiment of the present invention which includes a number of plugs bound into a unitary plate;

FIG. 7 illustrates a third embodiment of the present invention in which a number of plugs have been fashioned from the heating plate;

FIG. 8 shows a fourth embodiment of the present invention having reduced volume wells and a second type of plug;

FIG. 9 shows a fifth embodiment of the present invention, having reduced well volume and a third type of plug; and

FIG. 10 illustrates comparative data from a conventional plate and seal, a cycleplate and metal plugs, and a low-volume plate with metal plugs.

### BEST MODE FOR CARRYING OUT THE INVENTION

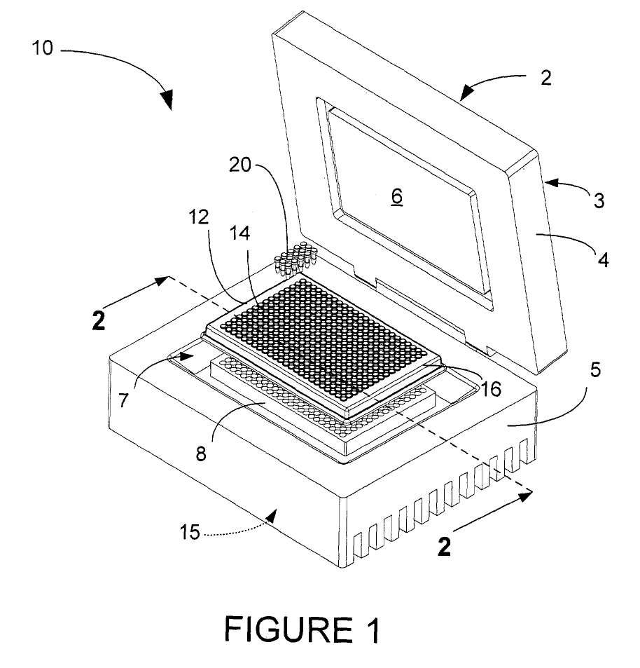

A preferred embodiment of the present invention is a system for reducing the volume of material used in laboratory processing, including low volume micro-plates and volume-limiting plugs. As illustrated in the various drawing herein, and particularly in the view of FIG. 1, a form of this preferred embodiment of the inventive device is depicted by the general reference character 10.

FIGS. 1-3 illustrate a machine for processing laboratory samples, which in this case, will be assumed to be a machine 2 for Polymerase Chain Reaction (PCR) cycling. It should be understood that other types of machines for laboratory processing can be used with the present invention, whenever the volume of samples is desired to be reduced, and the particular details of the processes allow. The PCR machine includes a cabinet 3 which has a lid 4 and an enclosure 5, which are attached by a hinge. The lid 4 includes a heater plate 6, which is used to minimize the effects of evaporation and condensation in the samples and reagents for amplification and sequencing processes. The enclosure 5 includes a central cavity 7 into which a pedestal 8 has been fashioned. The pedestal 8 is connected to a Peltier module 15 that heats and cools the pedestal, plates and wells. The pedestal 8 is a heavy metal block that can change temperature rapidly in response to the heating and cooling system in the PCR machine. There is a fan (not shown) for cooling under the Peltier module 15 and the module 15 is also wired to a heating system not shown.

A multi-well plate 12 is shown, which can be a standard 384 well-plate with 50 μL (50 micro-liter=50×10⁻⁶ liters) capacity wells, or can be a low-volume multi-well plate, as discussed below. The multi-well plate 12 includes a number of wells 14, of which 384 wells in an array of 16×24 wells is preferred. The wells 14 are separated by a matrix 16 of connecting material which maintains the wells in ordered spatial relation to each other. The wells 14 may contain samples 18 which are to be processed. A number of plugs 20 are shown for which there would actually be one for each well 14, but which are reduced in number here for ease of viewing.

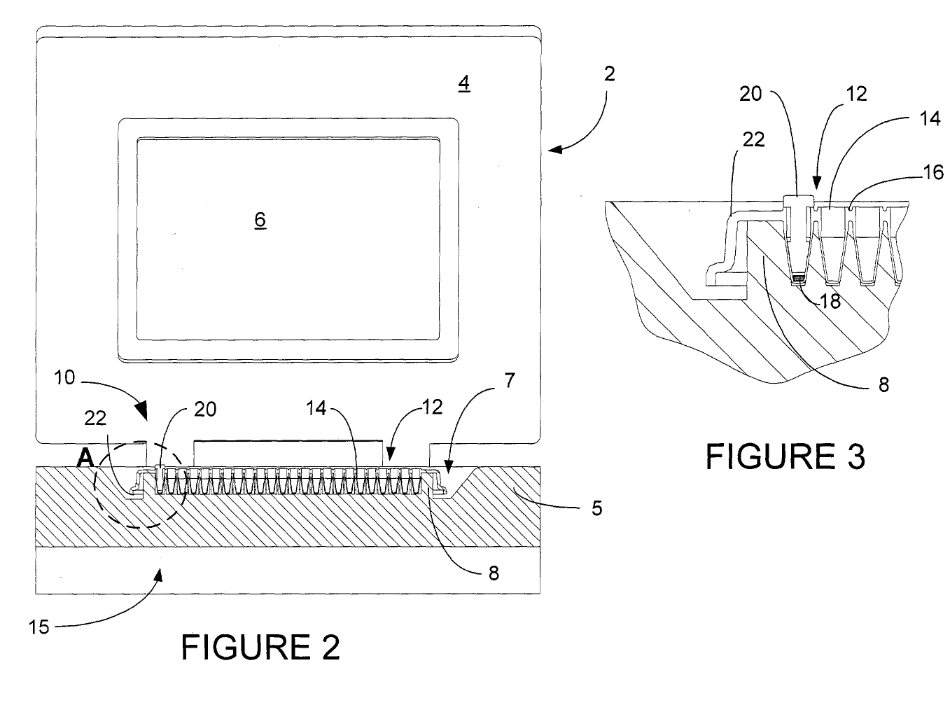

FIG. 2 shows the PCR machine 2 from a front cut-away view as seen from the line 2-2 in FIG. 1, and FIG. 3 shows a detail view of the area seen in detail circle A of FIG. 2. The lid 4, heating plate 6, pedestal 8, Peltier module 15, multiwell plate 12 with wells 14, matrix portion 16, and one plug 20 are seen. The well-plate 12 preferably includes a lip portion 22 which fits over the pedestal 8 to position the plate 12 accurately and hold it in place.

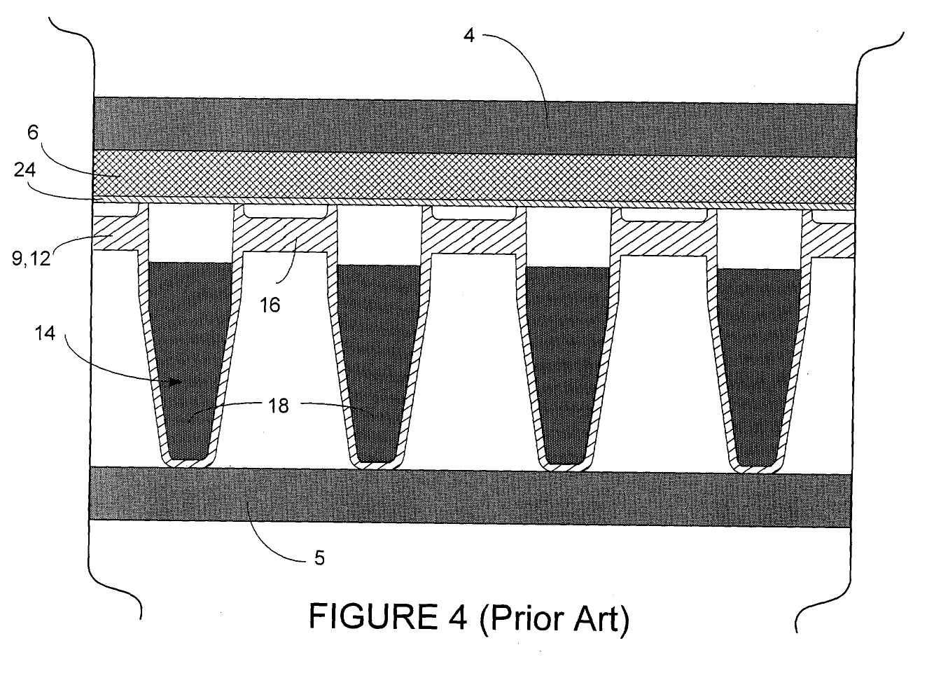

As shown in FIG. 4 (Prior Art), the usual operation of the PCR machine typically involved placing a standard well-plate 9, 12 into the box 5, and covering it with a plastic seal 24, which helps to decrease evaporation. This seal is not limited to plastic, but may be of other materials, and may include a film of mineral oil. The heating plate 6 then engages the seal 24 and the tops of the wells 14 and the Peltier module 15 heats and cools the samples 18 through the necessary cycles.

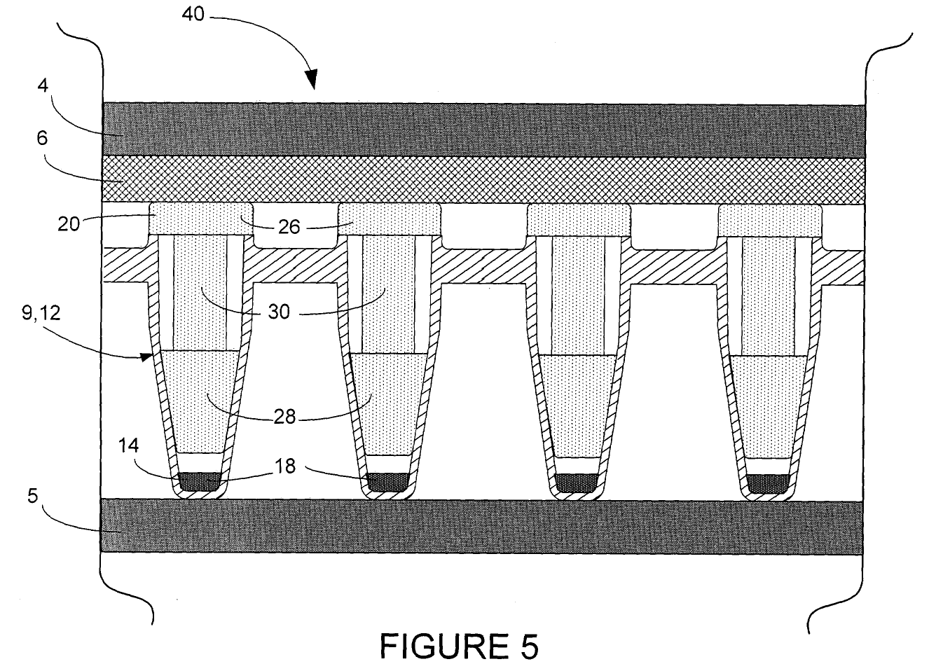

FIG. 5 shows a first embodiment 40 of the system of the present invention. In this embodiment, a standard multi-well plate 9, 12 is placed in the box 5, and plugs 20 are inserted into the wells 14. The plugs 20 are metal or preferably plastic, and have head 26 which are in contact with two heating plate 6 and tips 28 which are connected by a shank portion 30. The volume of the wells 14 has been effectively reduced to 2 μL, the sample material 18 has been drastically reduced, and may be as little as 0.8 μL, a reduction in volume, and cost in materials, of a factor of 25. Of course, it would have been possible in the prior art to simply reduce the amount of material placed in the wells. However, the plugs 20 greatly reduce evaporation over the seals 24 seen in FIG. 4, as the available surface area of the wells 14 is also greatly reduced. The tips 28 confine vapors to a small area, and the plugs 20 additionally provide thermal conduction to the vicinity of the sample material 18. This reduces the evaporation and condensation of materials in the wells and helps the concentrations of PCR reactants to remain more constant, which is very critical to success of the operations.

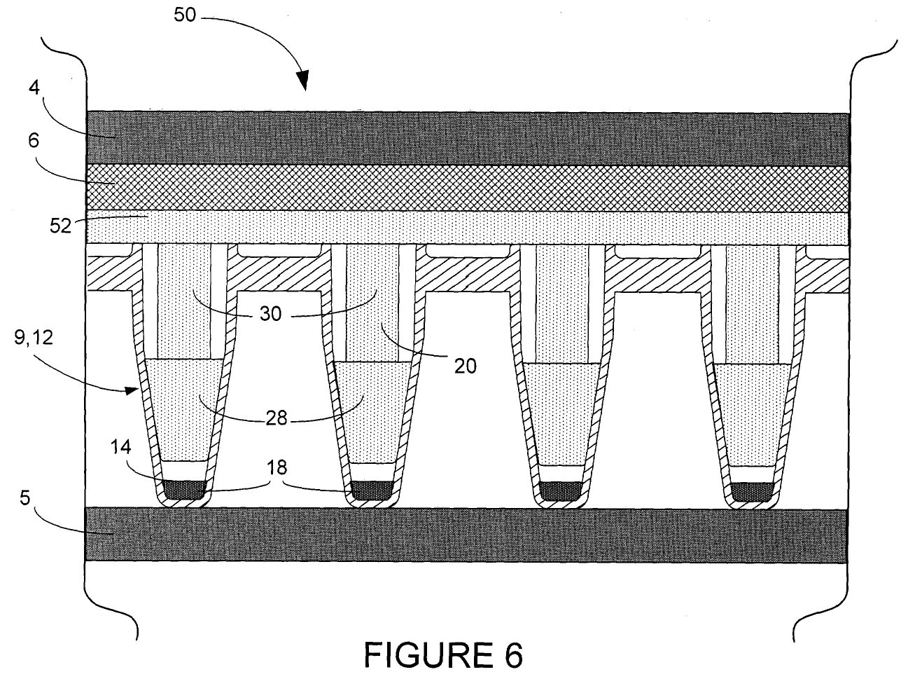

FIG. 6 shows a second embodiment 50 in which the individual plugs 20 have been bound together in a single continuous plate 52 with multiple shanks 30 and tips 28 that protrude into the wells 14 of the multi-well plate 12. The same benefits of improved heat transfer, reduced volumes and reduced evaporation/condensation also apply. This embodiment 50 has the added benefit that all pins 20 can be installed simultaneously, thus reducing processing time further.

The Society of Biomolecular Screening (SBS) has established standard XY dimensions for multi-well microplates. Two of the most commonly used standardized configurations are 96 well microplates with 9 mm center-to center spacing, and 384 well microplates with 4.5 mm spacing. This has allowed many processes to be automated. The spacing of the plugs 20 and the reduced volume wells, as discussed below, also preferably conform to this same center-to-center spacing.

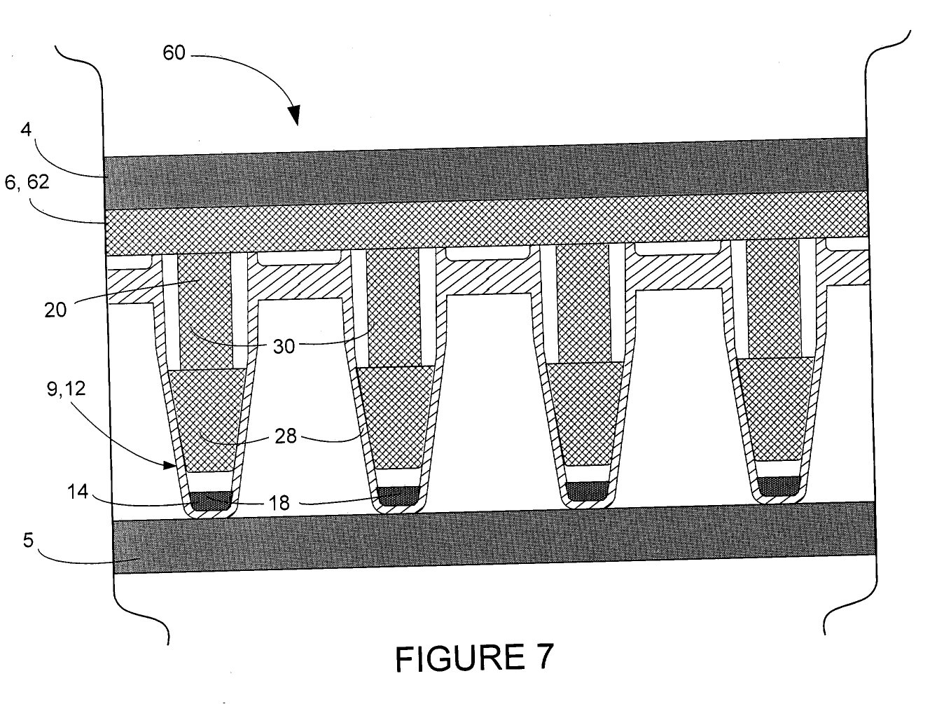

FIG. 7 shows a third embodiment 60, in which the heating plate 6 of the PCR machine 2 has been formed to include plugs 20, whose shafts 30 and tips 28 also protrude into the wells 14 of the well-plates 12, thus allowing reduced volume of materials 18 to as little as 0.8 μL.

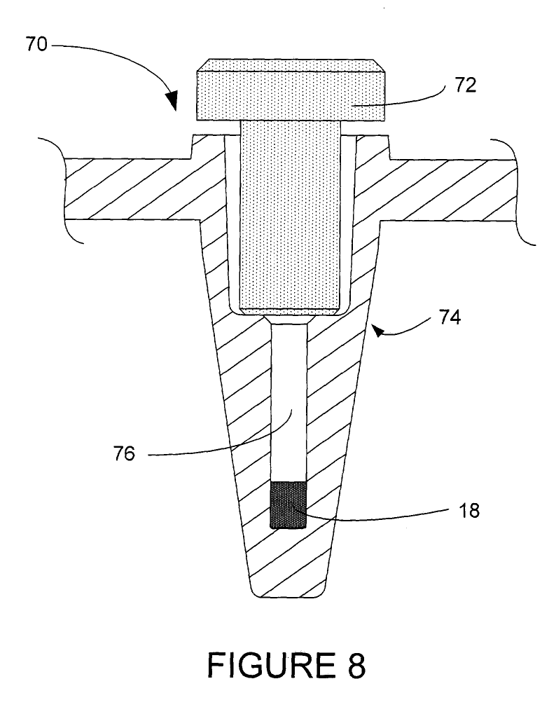

FIG. 8 illustrates a fourth embodiment 70 in which the actual capacity of the wells 74 have been reduced, preferably to 2 μL. A secondary well 76 with reduced volume is introduced, and a second type of plug 72 is used to seal the top of the secondary well 76. The 2 μL well has then been filled to only a fraction of its capacity, perhaps to as little as 0.5 μL, from which good sequencing results have still been obtained.

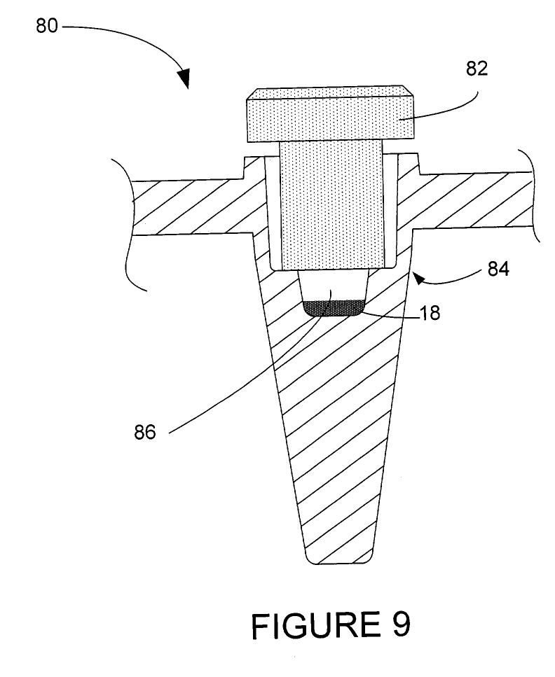

FIG. 9 shows a fifth embodiment 80 in which the capacity of the wells 84 have also been reduced, again preferably to 2 μL. A secondary well 86 with reduced volume is configured differently, and a third type of plug 82 is used to seal the top of the secondary well 86. Once again, good sequencing results have still been obtained when the 2 μL well has been filled to only a fraction of its capacity, perhaps to as little as 0.5 μL.

It will be obvious to one skilled in the art that many different variations in shape and configuration of the wells and plugs are possible. For example, there may be no secondary wells as such, but only a reduced volume well which is plugged in a similar manner to that shown in the first embodiment 10 (see FIG. 5). Also, it will be obvious that the use of a continuous plate 52 in the manner of the second embodiment 50 (see FIG. 6) or a configured heating plate 62 as in the third embodiment 60 (see FIG. 7) can be used with either or any of these reduced volume wells 74, 84 of the fourth embodiment 70 and fifth embodiment 80. It is also obvious that volume limiting plugs 20 of the present invention may be used with standard multi-well plates and that low-volume micro-plates 70,80 of the present invention may be used with standard plugs. In both cases the amount of material will be reduced, with comparable cost savings.

Recently, a base calling program called “Phred” has been developed for DNA sequence traces, which is capable of generating base-specific quality scores. These Phred scores have become widely accepted as a way to characterize the quality of sequences, in order to compare different sequencing reactions. Quality scores are logarithmically linked to error probabilities, so that a Phred quality score of 10 has a probability that a base is called wrong of 1in 10, or 90% accuracy, a Phred of 20 has 99% accuracy, a Phred of 30 has 99.9% accuracy, etc.

Another useful indicator of the quality of the results is found in regard to the “Read Length” which is a measure of the number of DNA sequence bases scientists can read from the sequencing reaction. Coupling the length of the sequence with the Phred numbers gives a measure of the “Read Length Phred>20”, meaning the length of a sequence for which 99% accuracy is obtained.

A simple way to look at a “PHRED analysis” is to treat it as a measurement of the quality of one sequence reaction. The more the PHRED read length is, the more DNA sequence bases scientists can read from the sequencing reaction, so the more information scientists can gather from one reaction. Typically an “Excellent” sequencing reaction will yield more than 700 bases of “Read Length Phred>20”. A “Good” sequencing reaction will give us about 400-700“Read Length Phred >20”. If a reaction totally doesn't work, than the Read Length Phred is 0 (i.e. one can not get any information from the reaction).

Thus, these numbers are useful in comparing the quality of results obtained by standard methods using 50 μL well, first with a standard cycleplate and plugs, as discussed above with regard to the first through third embodiments 40, 50, 60, shown in FIGS. 5-7, and secondly as discussed with regard to the prototype low-volume plate and plugs, as in the fourth and fifth embodiments 70 and 80, shown in FIGS. 8 and 9.

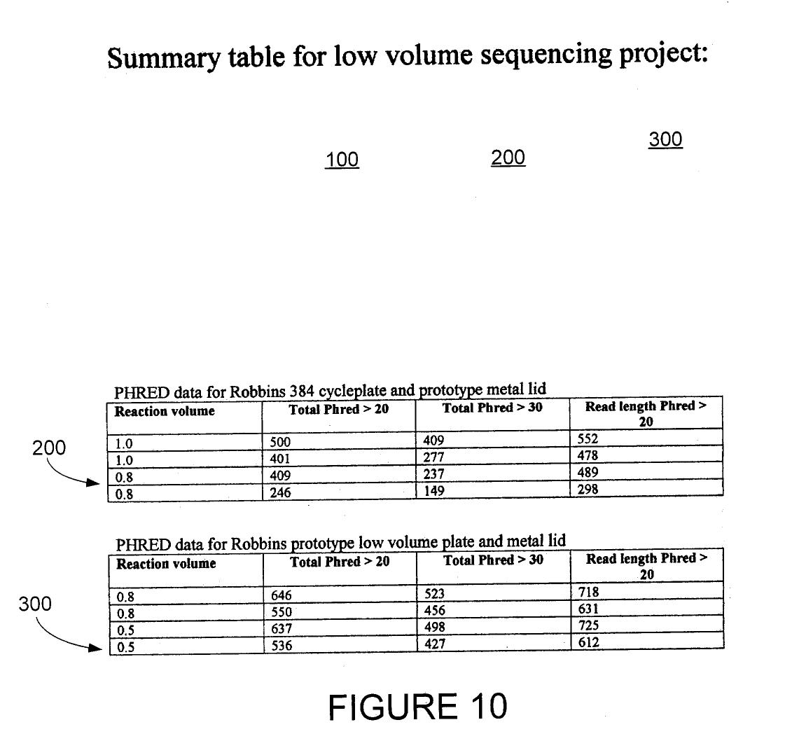

FIG. 10 shows tables of comparison of Read length Phred>20 data between the conventional plate and seal, the column indicated by the element number 100, with data obtained from a cycleplate with metal lid, or the plugs discussed above, column indicated by element number 200, and prototype low-volume plate with prototype metal lid, also meaning plugs, and indicated in column marked 300.

The reaction did not even occur for volumes less than 2.5 μL in column 100, or for volumes less than 0.8 μL in column 200, whereas data was obtained for volumes as low as 0.5 μL in column 300, which still produces results considered to be well within the “Good” range of Phred 400-700, and produced “Excellent” results in volumes as low as 1.0 μL. Thus the present invention provides a way to produce results that are good to excellent, while greatly reducing the cost of laboratory procedures by reducing the required amounts of materials. Additional Phred data is shown for elements labeled 200 and 300, corresponding to the cycleplate with lid of metal or other materials such as plastic, and prototype low-volume plate with prototype lid of metal or other materials such as plastic, respectively.

As referred to above, the present invention is useful in a variety of laboratory operations, including amplification by Polymerase Chain Reaction (PCR), DNA sequencing, Rolling Circle Amplification (RCA) and in fact any laboratory operation using multi-well plates where the volume of materials is desired to be reduced.

While various embodiments have been described above, it should be understood that they have been presented by way of example only, and not limitation.

### INDUSTRIAL APPLICABILITY

The volume reducing system 10 of the present invention having volume reducing plugs 20 which are bound into a plate 52, or included in a configured heating plate 62, as well as reduced volume wells 74, 84, is designed to be used for many applications involving the testing and analysis of chemical compounds on a micro scale. The many advantages of doing work on a micro-scale include the reduced costs of reagents, solvents and materials due to the reduced amounts needed, and the generation of less waste materials which may be environmentally damaging and costly to dispose of. The present invention 10 is expected to be especially useful for the amplification and sequencing of DNA such as Polymerase Chain Reactions (PCR) and Rolling Circle Amplification (RCA).

Both PCR and RCA and sequencing techniques involve the use of enzymes which are very expensive. A large portion of the cost incurred by DNA sequencing and amplification is due to the high cost of the enzyme, primers, and dye terminators used during cycle sequencing or PCR. The multi-well plates used in these operations typically hold volumes of 20 μL of material, which can cost in excess of $7.00 per reaction. Since some labs now reach throughputs in excess of 100,000 samples per day, the cost of performing the cycle sequencing reaction alone can represent a significant amount of the total cost of obtaining sequencing data.

To reduce this cost, many laboratories have reduced the reaction volumes and diluted the stock enzyme/dye terminator mix (referred to as ‘brew”). However, substantial dilution of brews can lead to lowering of sequence quality, and there are technical problems limiting volume reduction as well, such as excessive evaporation of the sample during heat cycling. Also, reduced volume gives more top space for condensation during the cool cycle, and there can also be difficulties in handling samples of such small volume.

In a first embodiment 40 of the system of the present invention, volume-reducing plugs 20 are inserted into the wells 14. The plugs 20 are metal or preferably plastic, and have heads 26 which are in contact with the heating plate 6 and tips 28 which are connected by a shank portion 30. By using the plugs 20, the volume of the wells 14 has been effectively reduced from 50 μL to 2 μL, and the sample material 18 has been drastically reduced, and may be as little as 0.8 μL, a reduction in volume, and cost in materials, of a factor of 25. The plugs 20 greatly reduce evaporation, as the available surface area of the wells 14 is also greatly reduced. The tips 28 confine vapors to a small area, and the plugs 20 additionally provide thermal conduction to the vicinity of the sample material 18. This reduces the evaporation and condensation of materials in the wells and helps the concentrations of PCR reactants to remain more constant, which is very critical to success of the operations.

A second embodiment 50 of the system of the present invention 10 uses individual pins 20 which have been bound together in a single continuous plate 52 with multiple shanks 30 and tips 28 that protrude into the wells 14 of the multi-well plate 12. The same benefits of improved heat transfer, reduced volumes and reduced evaporation/condensation are obtained. This embodiment 50 has the added benefit that all pins 20 can be installed simultaneously, thus reducing processing time further.

A third embodiment 60 uses a heating plate 6 of the PCR machine 2 which has been formed to include pins 20, whose shafts 30 and tips 28 also protrude into the wells 14 of the well-plates 12, thus allowing reduced volume of materials 18 to as little as 0.8 μL.

A fourth embodiment 70 has wells 74 in which the actual capacity of each well has been reduced, preferably to 2 μL by providing a secondary well 76 with reduced volume. A second type of plug 72 is used to seal the top of the secondary well 76. The 2 μL well has then been filled to only a fraction of its capacity, perhaps to as little as 0.5 μL, from which good sequencing results have still been obtained.

A fifth embodiment 80 has wells 84 in which the capacity of each well has also been reduced, again preferably to 2 μL. A secondary well 86 with reduced volume is configured differently, and a third type of plug 82 is used to seal the top of the secondary well 86. Once again, good sequencing results have still been obtained when the 2 μL well has been filled to only a fraction of its capacity, perhaps to as little as 0.5 μL.

In all of these embodiments, results were produced that were rated as “Good” to “Excellent” based on Phred numbers, and at a cost which has been significantly reduced by as much as a factor of 25.

The volume limiting plugs 20 and low-volume micro-plates 70,80 maybe be used together as part of a system 10, but the volume limiting plugs 20 may also be used with standard multi-well plates, and low-volume micro-plates 70,80 used with standard plugs or seals, with expected results of saving materials.

For the above, and other reasons, it is expected that the volume reducing system 10 will have widespread industrial applicability. Therefore, it is expected that the commercial utility of the present invention will be extensive and long lasting.

LOW VOLUME MICRO-PLATE AND VOLUME-LIMITING PLUGS
Inventor: AZARANI, Arezou, et.al
Atty. Ref.: 60435-301600 (RSC1P016+)
THIS CORRESPONDENCE CHART IS FOR EASE OF
UNDERSTANDTNG AND INFORMATIONAL PURPOSES ONLY,
AND DOES NOT FORM A PART OF THE FORMAL PATENT
APPLICATION.

| | |
|---|---|
| 2 | PCR machine |
| 3 | cabinet |
| 4 | lid |
| 5 | enclosure |
| 6 | heating plate |
| 7 | cavity |
| 8 | pedestal |
| 9 | standard multi-well plate |
| 10 | volume reducing system |
| 12 | multi-well plate |
| 14 | wells |
| 15 | Peltier module |
| 16 | matrix |
| 18 | samples |
| 20 | plugs |
| 22 | lip |
| 24 | plastic seal |
| 26 | head |
| 28 | tip |
| 30 | shank |
| 40 | first embodiment |
| 50 | second embodiment |
| 52 | continuous plate |
| 60 | third embodiment |
| 62 | configured heating plate |
| 70 | fourth embodiment |
| 72 | second type plug |
| 74 | wells |
| 76 | secondary well |
| 80 | fifth embodiment |
| 82 | third type plug |
| 84 | wells |
| 86 | secondary wells |
| 100 | data-conventional wells |
| 200 | data-cycleplate with plugs |
| 300 | data-low-volume plate and plugs |

What is claimed is:

1. Volume limiting plugs for use with multi-well plates, each volume limiting plug comprising:
a shank portion; and
a tip portion, said shank and tip portions configured to extends a substantial distance into a well of a multi-well plate to reduce the volume of the well.

2. The volume limiting plugs of claim 1, wherein:
said plugs are independent and detached from each other.

3. The volume limiting plugs of claim 1, wherein:
said plugs are bound together in a continuous plate.

4. The volume limiting plugs of claim 3, wherein:
said plugs are spaced in accordance with Society of Biomolecular Screening (SBS) standard XY dimensions.

5. The volume limiting plugs of claim 1, wherein:
said plugs are bound together in a configured heating plate.

6. The volume limiting plugs of claim 5, wherein:
said plugs are spaced in accordance with Society of Biomolecular Screening (SBS) standard XY dimensions.

7. The volume limiting plugs of claim 1, wherein:
said plugs are used with wells having reduced interior volume.

8. The volume limiting plugs of claim 7, wherein:
said plugs are independent and detached from each other.

9. The volume limiting plugs of claim 7, wherein:
said plugs are bound together in a continuous plate.

10. The volume limiting plugs of claim 9, wherein:
said plugs are spaced in accordance with Society of Biomolecular Screening (SBS) standard XY dimensions.

11. The volume limiting plugs of claim 7, wherein:
said plugs are bound together in a configured heating plate.

12. The volume limiting plugs of claim 11, wherein:
said plugs are spaced in accordance with Society of Biomolecular Screening (SBS) standard XY dimensions.

13. The volume limiting plugs of claim 7, wherein:
said wells having reduced interior volume have secondary wells, and said plugs are configured to seal said secondary wells.

14. A low-volume micro-plate for use in laboratory processing of materials, comprising:
a plurality of wells bound together with matrix material, said wells including secondary wells having reduced volume.

15. The low-volume micro-plate of claim 14, wherein:
said wells are spaced in accordance with Society of Biomolecular Screening (SBS) standard XY dimensions.

16. The low-volume micro-plate of claim 14, wherein:
said low-volume micro-plate is configured to receive volume-reducing plugs.

17. The low-volume micro-plate of claim 16, wherein:
said volume-reducing plugs are independent and detached from each other.

18. The low-volume micro-plate of claim 16, wherein:
said volume-reducing plugs are bound together in a continuous plate.

19. The low-volume micro-plate of claim 18, wherein:
said plugs are spaced in accordance with Society of Biomolecular Screening (SBS) standard XY dimensions.

20. The low-volume micro-plate of claim 16, wherein:
said volume-reducing plugs are bound together in a configured heating plate.

21. The low-volume micro-plate of claim 20, wherein:
said plugs are spaced in accordance with Society of Biomolecular Screening (SBS) standard XY dimensions.

22. The low-volume micro-plate of claim 14, wherein:
said low-volume micro-plate is configured to receive volume-reducing plugs which are configured to seal said secondary wells.

23. The low-volume micro-plate of claim 14, wherein:
said secondary wells have a substantially reduced interior diameter.

24. The low-volume micro-plate of claim 13, wherein:
said secondary wells have a substantially reduced interior depth.

25. A system for reducing volume of material used in laboratory processes, comprising:
a low-volume micro-plate for use in laboratory processing of materials, having a plurality of wells bound together with matrix material, said wells including secondary wells having reduced volume; and
volume limiting plugs for use with multi-well plates, each volume limiting plug having
a shank portion and a tip portion, said shank and tip portions configured to extends a substantial distance into a well of a multi-well plate to reduce the volume of the well.

26. The system for reducing volume of material of claim 25, wherein:
said wells are spaced in accordance with Society of Biomolecular Screening (SBS) standard XY dimensions.

27. The system for reducing volume of material of claim 25, wherein:
said volume-reducing plugs are independent and detached from each other.

28. The system for reducing volume of material of claim 25, wherein:
said volume-reducing plugs are bound together in a continuous plate.

29. The system for reducing volume of material of claim 25, wherein:
said volume-reducing plugs are bound together in a configured heating plate.
